(19) United States
(12) Patent Application Publication
(10) Pub. No.: US 2025/0103924 A1
(43) Pub. Date: Mar. 27, 2025

(54) INFORMATION PROCESSING DEVICE, NON-TRANSITORY COMPUTER-READABLE STORAGE MEDIUM, AND INFORMATION PROCESSING METHOD

(71) Applicant: MITSUBISHI ELECTRIC CORPORATION, Tokyo (JP)

(72) Inventors: Jia QU, Tokyo (JP); Shotaro MIWA, Tokyo (JP)

(73) Assignee: MITSUBISHI ELECTRIC CORPORATION, Tokyo (JP)

(21) Appl. No.: 18/972,647

(22) Filed: Dec. 6, 2024

Related U.S. Application Data
(63) Continuation of application No. PCT/JP2022/026708, filed on Jul. 5, 2022.

(51) Int. Cl. G06N 5/045

(52) U.S. Cl. CPC G06N 5/045

(57) ABSTRACT

An information processing device includes an attention mechanism unit that uses an attention-mechanism learning model to calculate a context variable by weighting a plurality of input data items organized as a time-series or a plurality of variables calculated from the input data items with a plurality of weight values and adding the weighted input data items or the weighted variables; a decision unit that infers a single decision from a plurality of decisions on a basis of confidence levels of the plurality of decisions calculated from the context variable, and a latest input data item included in the plurality of input data items or a latest variable included in the plurality of variables; and a data extracting unit that extracts at least one input data item that is a factor in the inference, from the plurality of input data items by referring to the plurality of weight values.

### CROSS REFERENCE TO RELATED APPLICATION

This application is a continuation application of International Application No. PCT/JP2022/026708 having an international filing date of Jul. 5, 2022, which is hereby expressly incorporated by reference into the present application.

### BACKGROUND OF THE INVENTION

### 1. Field of the Invention

The disclosure relates to an information processing device, a non-transitory computer-readable storage medium, and an information processing method.

### 2. Description of the Related Art

There is an attention mechanism as a technique to improve the accuracy of an inference made by a learning model. For example, the anomaly detecting device described in PTL 1 includes an anomaly detecting unit that detects anomalies in time-series data. The anomaly detecting unit includes an encoding unit that encodes the time-series data by using multiple LSTM cells; an attention layer that calculates the attention weight for an output from the encoding unit; a context generating unit that applies the weight to an output from the encoding unit to generate a context vector; and a decoding unit that reconstructs the time-series data by using the LSTM cells on the basis of the context vector, to achieve improved accuracy and efficient learning for anomaly detection.
Patent Literature 1: International Publication No. 2021/100179

### SUMMARY OF THE INVENTION

However, the internal processing of a learning model using deep reinforcement learning is a backbox and thus is not visible. For this reason, a user cannot easily understand how a decision is made in a learning model.

Accordingly, it is an object of at least one aspect of the disclosure to easily pinpoint data that serves as the basis of a decision made by a learning model using an attention mechanism.

An information processing device according to an aspect of the disclosure includes: processing circuitry to use an attention-mechanism learning model to calculate a context variable by weighting a plurality of input data items organized as a time-series or a plurality of variables calculated from the input data items with a plurality of weight values and adding the weighted input data items or the weighted variables, the attention-mechanism learning model being a learning model of an attention mechanism; to infer a single decision from a plurality of decisions on a basis of confidence levels of the plurality of decisions calculated from the context variable, and a latest input data item included in the plurality of input data items or a latest variable included in the plurality of variables; and to extract at least one input data item from the plurality of input data items by referring to the plurality of weight values, the at least one input data item being a factor in the inference of the single decision.

Accordingly, at least one aspect of the disclosure can easily pinpoint data that serves as the basis of a decision made by a learning model using an attention mechanism.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of an information processing device according to a first embodiment;

FIGS. 2A and 2B are block diagrams illustrating hardware configuration examples;

FIG. 3 is a schematic diagram for explaining processing executed in the information processing device according to the first embodiment;

FIG. 4 is a block diagram schematically illustrating a configuration of an information processing device according to a second embodiment;

FIG. 5 is a schematic diagram for explaining processing executed in the information processing device according to the second embodiment;

FIG. 6 is a block diagram schematically illustrating a configuration of an information processing device according to a third embodiment; and

FIG. 7 is a schematic diagram for explaining processing executed in the information processing device according to the third embodiment.

### DETAILED DESCRIPTION OF THE INVENTION

### First Embodiment

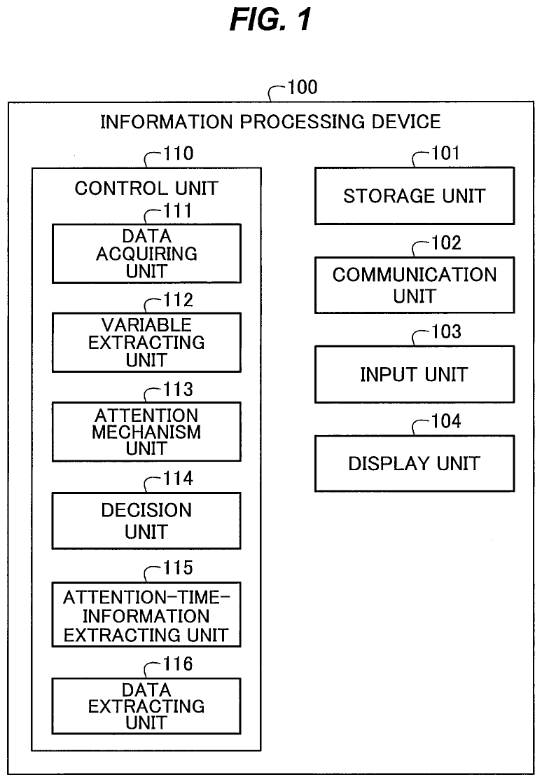

FIG. 1 is a block diagram schematically illustrating a configuration of an information processing device 100 according to the first embodiment.

The information processing device 100 includes a storage unit 101, a communication unit 102, an input unit 103, a display unit 104, and a control unit 110.

The storage unit 101 stores programs and data necessary for processing executed in the information processing device 100.

For example, the storage unit 101 stores at least an attention-mechanism learning model, which is a learning model used in an attention mechanism executed by the control unit 110. In the first embodiment, the storage unit 101 also stores an extractive learning model and a decision learning model, as will be described later.

The storage unit 101 also stores decision input-data information indicating input data that is decided to be important by an outcome of an inference made by the attention mechanism, in other words, input data that is a factor in the decision outcome.

The communication unit 102 communicates with other devices. For example, the communication unit 102 communicates with other devices via a network such as the Internet.

The input unit 103 accepts input from a user of the information processing device 100.

The display unit 104 displays information to a user of the information processing device 100. For example, the display unit 104 displays various screen images.

The control unit 110 controls processing executed in the information processing device 100. For example, the control unit 110 acquires input data and calculates state variables that are variables necessary for making a decision from the input data. The control unit 110 calculates a context state variable by performing weighed sum of the state variables through an attention mechanism, and infers a certain decision from the context state variable. The control unit 110 then refers to the weights added using the attention mechanism to extract the input data that is a factor in the decision outcome, which is the inferred decision, and stores the decision input-data information indicating the input data in the storage unit 101. Here, the extracted input data can be determined to have had a significant influence on the inference.

In the following, a state variable is also simply referred to as a variable, and a context state variable is also simply referred to as a context variable.

The control unit 110 includes a data acquiring unit 111, a variable extracting unit 112, an attention mechanism unit 113, a decision unit 114, an attention-time-information extracting unit 115, and a data extracting unit 116.

The data acquiring unit 111 acquires input data. The data acquiring unit 111 may acquire the input data, for example, via the communication unit 102. When input data is stored in the storage unit 101, the data acquiring unit 111 may acquire the input data from the storage unit 101. It is assumed that the input data acquired here is time-series data. The acquired input data is given to the variable extracting unit 112 and the data extracting unit 116.

The variable extracting unit 112 extracts state variables that can be used for making a decision, from the input data acquired by the data acquiring unit 111.

Here, the variable extracting unit 112 extracts state variables by using an extractive learning model, which is a learning model for extracting state variables from input data. The state variables extracted by the variable extracting unit 112 are assumed to be organized as a time-series.

The attention mechanism unit 113 calculates a context state variable by performing a weighted sum by using a known attention mechanism on the state variables extracted by the variable extracting unit 112. For example, the attention mechanism unit 113 infers multiple weight values by using an attention-mechanism learning model stored in the storage unit 101 on the state variables extracted by the variable extracting unit 112, adds weights by using the weight values, and adds the weighted state variables to calculate a context state variable as an inference outcome.

The decision unit 114 infers a single decision from multiple decisions on the basis of the confidence levels of the multiple decisions calculated from the context state variable inferred by the attention mechanism unit 113 and the latest state variable included in the multiple state variables.

Here, the decision unit 114 makes an inference by using a decision learning model, which is a learning model for inferring a single decision from a context variable.

The attention-time-information extracting unit 115 generates attention time information indicating multiple weight values inferred by the attention mechanism unit 113 and the times of the input data corresponding to the state variables weighted by the respective weight values, and give the attention time information to the data extracting unit 116.

The data extracting unit 116 refers to the weight values indicated by the attention time information to extract an input data item or multiple data items that are a factor in the decision outcome, from the input data. In other words, the data extracting unit 116 extracts input data that is considered to have had a significant impact on the decision outcome and generates decision input-data information indicating this input data. The data extracting unit 116 then stores the decision input-data information in the storage unit 101.

Specifically, the data extracting unit 116 can determined that the input data that is a factor in the decision outcome consists of two sets of input data: one set being input data items corresponding to weight values that are indicated in the attention time information and exceed a predetermined threshold, or a first threshold, and the other set being pairs of input data items corresponding to pairs of weight values that are indicated in the attention time information and correspond to consecutive times and whose magnitude of change exceeds a predetermined threshold, or a second threshold. The magnitude of change may be a difference or a percentage.

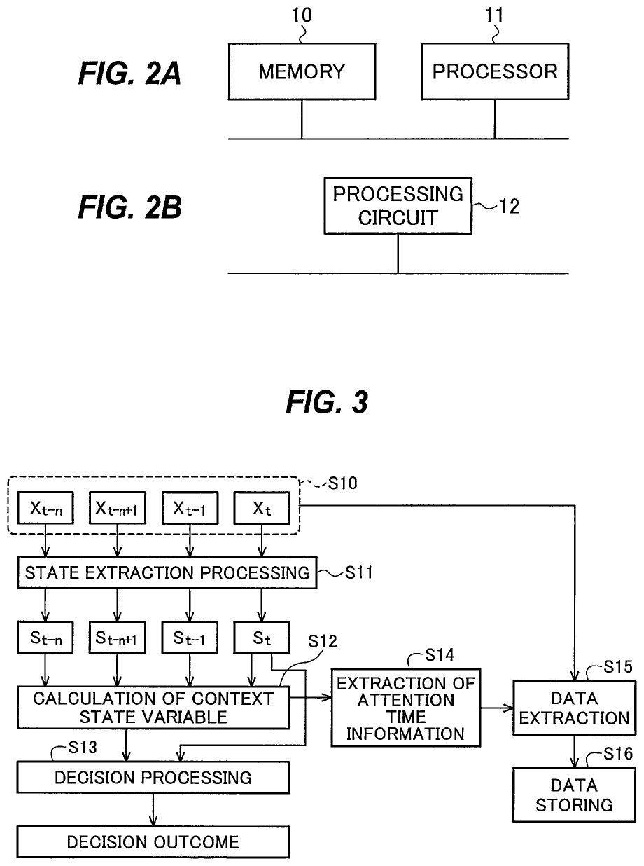

A portion or the entirety of the control unit 110 described above can be implemented by, for example, a memory 10 and a processor 11 such as a central processing unit (CPU) that executes programs stored in the memory 10, as illustrated in FIG. 2A. In other words, the information processing device 100 can be implemented by what is commonly known as a computer. Such programs may be provided over a network or may be recorded and provided on a recording medium such as non-transitory computer-readable storage medium. That is, such programs may be provided, for example, as a program product.

A portion or the entirety of the control unit 110 can also be implemented by, for example, a single circuit, a composite circuit, a processor operated by a program, a parallel processor operated by a program, or a processing circuit 12 such as an application specific integrated circuit (ASIC) or a field programmable gate array (FPGA), as illustrated in FIG. 2B.

As described above, the control unit 110 can be implemented by processing circuitry.

The storage unit 101 can be implemented by storage such as a hard disk drive (HDD) or a solid-state drive (SSD).

The communication unit 102 can be implemented by a communication interface such a network interface card (NIC).

The input unit 103 can be implemented by an input interface such as a keyboard or a mouse.

The display unit 104 can be implemented by a display.

FIG. 3 is a schematic diagram for explaining processing executed in the information processing device 100 according to the first embodiment.

First, the data acquiring unit 111 acquires input data Xₜ₋ₙ, Xₜ₋ₙ₊₁, Xₜ₋₁, Xₜ (step S10). Here, the input data Xₜ₋ₙ, Xₜ₋ₙ₊₁, Xₜ₋₁, Xₜ is sensor values that are observation values, and is the data of the time-series t−n, t−n+1, t−1, t (where t and n are positive integers). For example, image data can be used as input data.

The data acquiring unit 111 gives the acquired input data Xₜ₋ₙ, Xₜ₋ₙ₊₁, Xₜ₋₁, Xₜ to the variable extracting unit 112 and the data extracting unit 116.

The variable extracting unit 112 extracts, from the input data Xₜ₋ₙ, Xₜ₋ₙ₊₁, Xₜ₋₁, Xₜ, state variables Sₜ₋ₙ, Sₜ₋ₙ₊₁, Sₜ₋₁, and Sₜ, which are variables advantageous for the decision unit 114 to make a decision (step S11).

Here, the variable extracting unit 112 uses the extractive learning model, which is a neural network model stored in the storage unit 101, to extract the state variables Sₜ₋ₙ, Sₜ₋ₙ₊₁, Sₜ₋₁, and Sₜ from the input data Xₜ₋ₙ, Xₜ₋ₙ₊₁, Xₜ₋₁, Xₜ.

The variable extracting unit 112 gives the extracted state variables Sₜ₋ₙ, Sₜ₋ₙ₊₁, Sₜ₋₁, and Sₜ to the attention mechanism unit 113.

Here, the variable extracting unit 112 uses the extractive learning model; however, the first embodiment is not limited to such an example so long as the state variables Sₜ₋ₙ, Sₜ₋ₙ₊₁, Sₜ₋₁, and Sₜ are extracted using a function.

The attention mechanism unit 113 uses a learning model to infer weighted values for the state variables Sₜ₋ₙ, Sₜ₋ₙ₊₁, Sₜ₋₁, and Sₜ and calculates a weighted sum to calculate a context state variable (step S12).

The attention mechanism unit 113 gives the calculated context state variable to the decision unit 114.

The decision unit 114 makes a decision from the context state variable and the latest state variable Sₜ (step S13).

Here, the decision unit 114 uses the decision learning model, which is a neural network model stored in the storage unit 101, to infer a decision from the context state variable and the latest state variable.

In step S12, the attention-time-information extracting unit 115 extracts the weight values inferred by the attention mechanism unit 113 and the times of the corresponding input data, and generates attention time information indicating the extracted weight values and times (step S14). The generated attention time information is given to the data extracting unit 116.

The data extracting unit 116 refers to the attention time information to extract, from the input data, input data that is a factor in the decision outcome of the decision unit 114 and generates decision input-data information indicating the input data items (step S15).

The storage unit 101 then stores the decision input-data information generated by the data extracting unit 116 (step S16).

According to the first embodiment, it is possible to easily pinpoint data that serves as the basis of a decision made by a learning model using an attention mechanism.

### Second Embodiment

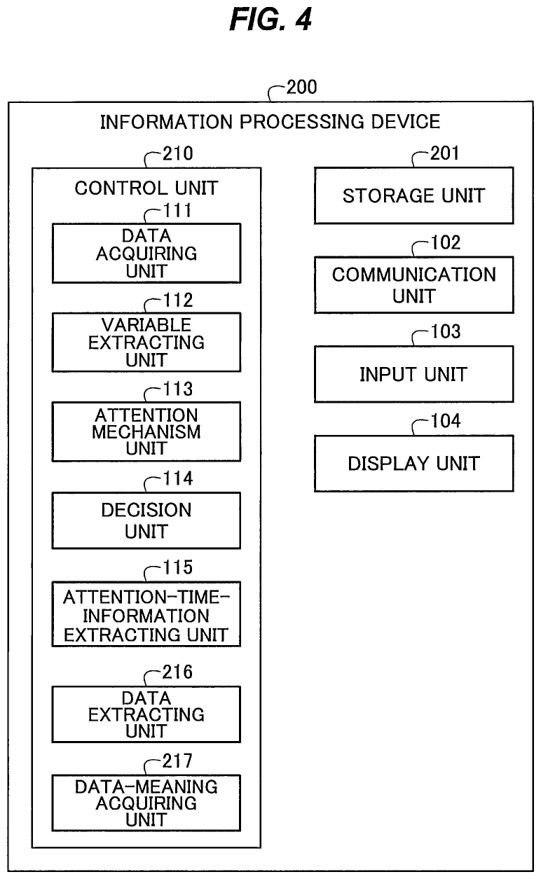

FIG. 4 is a block diagram schematically illustrating a configuration of an information processing device 200 according to the second embodiment.

The information processing device 200 includes a storage unit 201, a communication unit 102, an input unit 103, a display unit 104, and a control unit 210.

The communication unit 102, the input unit 103, and the display unit 104 of the information processing device 200 according to the second embodiment are respectively the same as the communication unit 102, the input unit 103, and the display unit 104 of the information processing device 100 according to the first embodiment.

The storage unit 201 stores programs and data necessary for processing executed in the information processing device 200.

The storage unit 201 according to the second embodiment stores the same data as in the first embodiment and also stores semantic input data generated by a control unit 210 described below.

The control unit 210 controls processing executed in the information processing device 200.

The control unit 210 according to the second embodiment extracts the meaning of input data and executes a process of interpreting a decision basis.

The control unit 210 includes a data acquiring unit 111, a variable extracting unit 112, an attention mechanism unit 113, a decision unit 114, an attention-time-information extracting unit 115, a data extracting unit 216, and a data-meaning acquiring unit 217.

The data acquiring unit 111, the variable extracting unit 112, the attention mechanism unit 113, the decision unit 114, and the attention-time-information extracting unit 115 of the control unit 210 according to the second embodiment are respectively the same as the data acquiring unit 111, the variable extracting unit 112, the attention mechanism unit 113, the decision unit 114, and the attention-time-information extracting unit 115 of the control unit 110 according to the first embodiment.

However, the data acquiring unit 111 according to the second embodiment gives the acquired input data to the variable extracting unit 112 and the data-meaning acquiring unit 217.

The data-meaning acquiring unit 217 acquires the meaning of the input data from the data acquiring unit 111. Here, the data-meaning acquiring unit 217 acquires the meaning of the input data by accepting input of the meaning of the input data from a user via the input unit 103. For example, when the input data is image data, the meaning of the input data is identification information (for example, the name of a target) for identifying a target such as a person or an object included in the image data.

The data-meaning acquiring unit 217 then stores semantic input data obtained by adding the meaning of the input data to the input data in the storage unit 201.

The data extracting unit 216 interprets a decision basis that is the basis of a decision outcome by the decision unit 114 from the meaning of the input data that is a factor in the decision outcome.

For example, the data extracting unit 216 refers to attention time information to extract, from the semantic input data stored in the storage unit 201, semantic input data that is considered to have had a significant impact on the decision outcome. The data extracting unit 216 then interprets the decision basis of the decision outcome from the meaning of the extracted semantic input data. Regarding the interpretation of the decision basis, the method of interpretation should be determined in advance in accordance with the decision to be made by the decision unit 114 and the weight values. For example, when the weight values indicated by the attention time information rise rapidly, it can be interpreted that the target that appeared immediately before or after the rapid rise is the decision basis. When a weight value indicated by the attention time information exceeds a certain threshold, it can be interpreted that a physical quantity such as a distance, a position, or a magnitude of a predetermined target at that time is the decision basis. The predetermined target here may be defined in accordance with the decision to be made by the decision unit 114. For example, if the decision to be made by the decision unit 114 is an operation of a car, the predetermined target is an oncoming vehicle, a wall, a pedestrian, or the like.

The data extracting unit 216 then stores, in the storage unit 201, decision basis information indicating the decision basis that is the content interpreted from the extracted semantic input data. The decision basis information may include the semantic input data used for the interpretation of the decision basis.

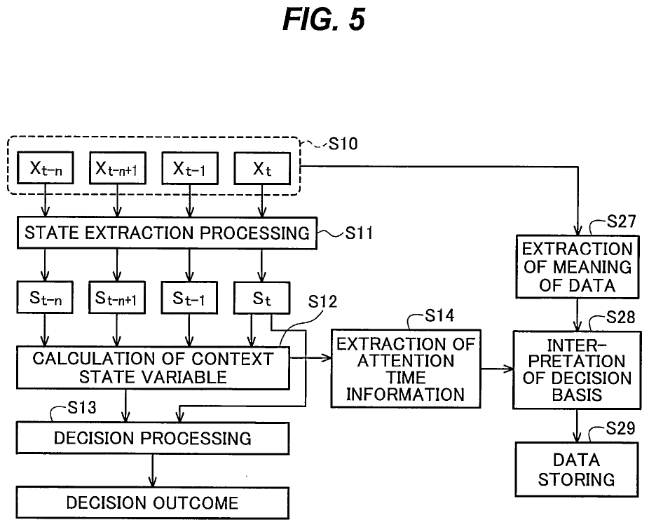

FIG. 5 is a schematic diagram for explaining processing executed in the information processing device 200 according to the second embodiment.

The processing of steps S10 to S14 in FIG. 5 is the same as the processing of steps S10 to S14 in FIG. 3.

In the second embodiment, the data-meaning acquiring unit 217 extracts the meaning of the input data from the data acquiring unit 111 and generates semantic input data by adding the meaning of the input data to the input data (step S27). The generated semantic input data is stored in the storage unit 201.

The data extracting unit 216 refers to attention time information to extract, from the semantic input data stored in the storage unit 201, semantic input data that is a factor in the decision outcome, and interprets the decision basis of the decision outcome from the meaning of the extracted semantic input data (step S28). The data extracting unit 216 then generates decision basis information indicating the content interpreted from the extracted semantic input data.

The storage unit 201 then stores the decision basis information (step S29).

As described above, according to the second embodiment, since decision basis information indicating the content interpreted as a decision is generated, the decision basis can be presented to a user in an easily understandable manner.

### Third Embodiment

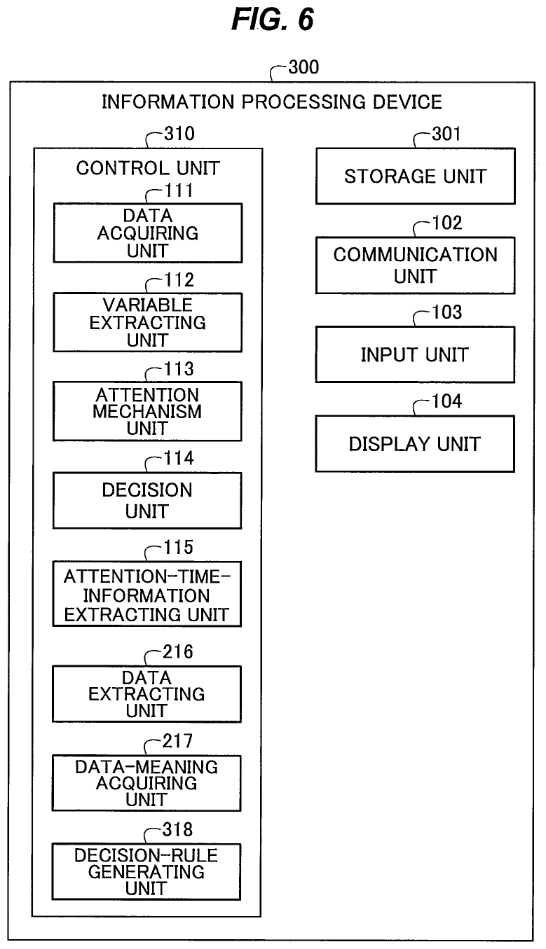

FIG. 6 is a block diagram schematically illustrating a configuration of an information processing device 300 according to the third embodiment.

The information processing device 300 includes a storage unit 301, a communication unit 102, an input unit 103, a display unit 104, and a control unit 310.

The communication unit 102, the input unit 103, and the display unit 104 of the information processing device 300 according to the third embodiment are respectively the same as the communication unit 102, the input unit 103, and the display unit 104 of the information processing device 100 according to the first embodiment.

The storage unit 301 stores programs and data necessary for processing executed in the information processing device 300.

The storage unit 301 according to the third embodiment stores the same data as in the first embodiment and also stores semantic input data and decision rules generated by the control unit 310 described later.

The control unit 310 controls processing executed in the information processing device 300.

As in the second embodiment, the control unit 310 according to the third embodiment extracts the meaning of input data and executes a process of interpreting a decision basis.

The control unit 310 according to the third embodiment generates a decision rule indicating a decision basis and a decision outcome inferred from semantic input data corresponding to the decision basis, and stores the decision rule in the storage unit 301.

The control unit 310 includes a data acquiring unit 111, a variable extracting unit 112, an attention mechanism unit 113, a decision unit 114, an attention-time-information extracting unit 115, a data extracting unit 216, a data-meaning acquiring unit 217, and a decision-rule generating unit 318.

The data acquiring unit 111, the variable extracting unit 112, the attention mechanism unit 113, and the decision unit 114 of the control unit 310 according to the third embodiment are respectively the same as the data acquiring unit 111, the variable extracting unit 112, the attention mechanism unit 113, and the decision unit 114 of the control unit 110 according to the first embodiment.

The data extracting unit 216 and the data-meaning acquiring unit 217 of the control unit 310 according to the third embodiment are respectively the same as the data extracting unit 216 and the data-meaning acquiring unit 217 of the control unit 210 according to the second embodiment.

The decision-rule generating unit 318 generates a decision rule that correlates a decision basis that is a content interpreted from semantic input data by the data extracting unit 216 and an inferred decision outcome. The decision rule may include the semantic input data used for the interpretation of the decision basis.

The decision-rule generating unit 318 then stores the decision rule in the storage unit 301.

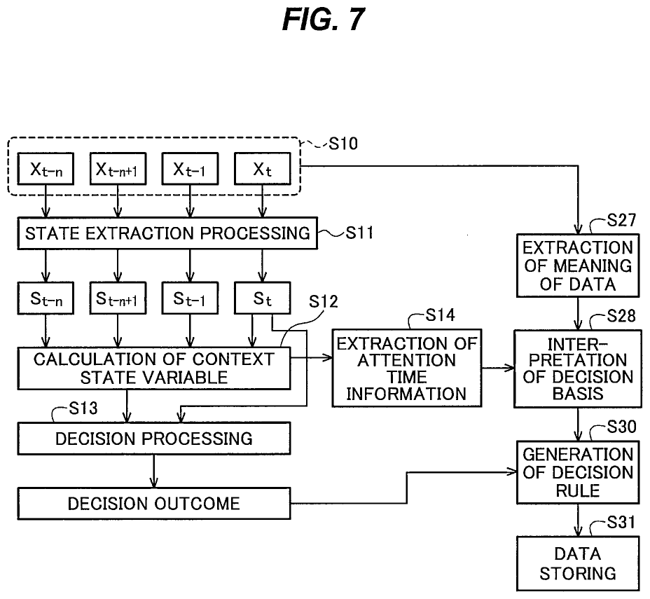

FIG. 7 is a schematic diagram for explaining processing executed in the information processing device 300 according to the third embodiment.

The processing of steps S10 to S14 in FIG. 7 is the same as the processing of steps S10 to S14 in FIG. 3.

As in the second embodiment, in the third embodiment, the data-meaning acquiring unit 217 extracts the meaning of input data from the data acquiring unit 111 and generates semantic input data by adding the meaning of the input data to the input data (step S27). The generated semantic input data is stored in the storage unit 301.

The data extracting unit 216 refers to attention time information to extract the semantic input data that is a factor in the decision outcome from the semantic input data stored in the storage unit 301 and interprets the decision basis of the decision outcome from the meaning of the extracted semantic input data (step S28).

The decision-rule generating unit 318 generates a decision rule indicating the decision basis interpreted in step S28 and the decision outcome inferred by the decision unit 114. The decision rule may include the semantic input data extracted in step S27.

The storage unit 301 then stores the decision rule (step S31).

As described above, according to the third embodiment, a decision rule indicating a decision basis and a decision outcome derived from the decision basis is generated, and by accumulating such decision rules, for example, a rule-based artificial intelligence (AI) model such as a known decision tree can be generated. Since a decision rule is in a format that is easy for a user to understand, the user can easily understand the content of an inference performed by the information processing device 300.

In the first to third embodiments described above, state variables are extracted from input data by the variable extracting unit 112, but the first to third embodiments are not limited to such an example. For example, when the input data is data suitable for processing, the processing by the variable extracting unit 112 may not be executed.

In such a case, the attention mechanism unit 113 uses an attention-mechanism learning model, which is a learning model of an attention mechanism, calculates a context variable by weighting multiple input data items that are organized as a time-series with multiple weight values and adding the weighted input data items. The decision unit 114 infers a decision from multiple decisions on the basis of the context variable and the confidence levels of the multiple decisions calculated from the latest input data item included in the multiple input data items.

What is claimed is:

1. An information processing device comprising:
processing circuitry
to use an attention-mechanism learning model to calculate a context variable by weighting a plurality of input data items organized as a time-series or a plurality of variables calculated from the input data items with a plurality of weight values and adding the weighted input data items or the weighted variables, the attention-mechanism learning model being a learning model of an attention mechanism;
to infer a single decision from a plurality of decisions on a basis of confidence levels of the plurality of decisions calculated from the context variable, and a latest input data item included in the plurality of input data items or a latest variable included in the plurality of variables; and
to extract at least one input data item from the plurality of input data items by referring to the plurality of weight values, the at least one input data item being a factor in the inference of the single decision.

2. The information processing device according to claim 1, wherein the processing circuitry extracts an input data item corresponding to one weight value included in the plurality of weight values when the one weight value exceeds a first threshold, the first threshold being a predetermined threshold.

3. The information processing device according to claim 1, wherein the processing circuitry extracts two input data items corresponding to two weight values included in the plurality of weight values when a magnitude of change between the two weight values corresponding to two consecutive times in the time-series exceeds a second threshold, the second threshold being a predetermined threshold.

4. The information processing device according to claim 1, wherein the processing circuitry acquires a meaning of the at least one input data item, and interprets a decision basis on which the one decision is inferred from the meaning of the at least one input data item.

5. The information processing device according to claim 4, wherein the processing circuitry generates a decision rule correlating the decision basis and the one decision.

6. The information processing device according to claim 5, further comprising:
a storage to store the decision rule.

7. A non-transitory computer-readable storage medium storing a program that causes a computer to execute processing comprising:
using an attention-mechanism learning model to calculate a context variable by weighting a plurality of input data items organized as a time-series or a plurality of variables calculated from the input data items with a plurality of weight values and adding the weighted input data items or the weighted variables, the attention-mechanism learning model being a learning model of an attention mechanism;
inferring a single decision from a plurality of decisions on a basis of confidence levels of the plurality of decisions calculated from the context variable, and a latest input data item included in the plurality of input data items or a latest variable included in the plurality of variables; and
extracting at least one input data item from the plurality of input data items by referring to the plurality of weight values, the at least one input data item being a factor in the inference of the single decision.

8. An information processing method comprising:
using an attention-mechanism learning model to calculate a context variable by weighting a plurality of input data items organized as a time-series or a plurality of variables calculated from the input data items with a plurality of weight values and adding the weighted input data items or the weighted variables, the attention-mechanism learning model being a learning model of an attention mechanism;
inferring a single decision from a plurality of decisions on a basis of confidence levels of the plurality of decisions calculated from the context variable, and a latest input data item included in the plurality of input data items or a latest variable included in the plurality of variables; and
extracting at least one input data item from the plurality of input data items by referring to the plurality of weight values, the at least one input data item being a factor in the inference of the single decision.
